(19) United States
(12) Patent Application Publication
(10) Pub. No.: US 2024/0388814 A1
(43) Pub. Date: Nov. 21, 2024

(54) IMAGING DEVICE

(71) Applicant: SONY SEMICONDUCTOR SOLUTIONS CORPORATION, KANAGAWA (JP)

(72) Inventor: ATSUSHI SUZUKI, KANAGAWA (JP)

(21) Appl. No.: 18/574,710

(22) PCT Filed: Mar. 15, 2022
(86) PCT No.: PCT/JP2022/011466

§ 371 Date: Dec. 27, 2023

(30) Foreign Application Priority Data
Jul. 7, 2021 (JP) 2021-112970

(51) Int. Cl. H04N 25/771; H04N 25/65; H04N 25/709; H04N 25/772; H04N 25/78

(52) U.S. Cl. CPC H04N 25/771; H04N 25/65; H04N 25/709; H04N 25/772; H04N 25/78

(57) ABSTRACT

To further reduce the pixel size. An imaging device includes: a plurality of pixels; and a holding unit that holds a signal output from the pixel. The pixel includes: a conversion unit that converts radiation or light into charges; a charge storage unit that stores the charges; a reset unit that resets the charges stored in the charge storage unit; a first amplification unit that amplifies a signal based on the charges stored in the charge storage unit; a second amplification unit that amplifies the signal amplified by the first amplification unit and outputs the signal such that the signal is held in the holding unit; a first capacitor connected between an output portion of the first amplification unit and an input portion of the second amplification unit; and a voltage control unit that controls a voltage at an input portion of the second amplification unit.

### TECHNICAL FIELD

Embodiments of the present disclosure relate to an imaging device.

### BACKGROUND ART

In a detection device (imaging device) that detects radiation or light, a method is known in which a signal voltage is read based on a charge converted according to a detected amount. In addition, for example, it has been proposed to arrange a circuit for reducing reset noise (kTC noise) generated by resetting the charge in the charge storage unit and a circuit for correcting noise components such as offset generated in a signal amplification unit within a pixel (see PTL 1).

### CITATION LIST

### Patent Literature

### [PTL 1]

JP 2016-82255A

### SUMMARY

### Technical Problem

However, when the above-described circuits are arranged within a pixel, the number of transistors within the pixel is large, making it difficult to reduce the pixel size.

Therefore, the present disclosure provides an imaging device that can further reduce the pixel size.

### Solution to Problem

In order to solve the above problems, according to the present disclosure, there is provided
an imaging device including: a plurality of pixels; and
a holding unit that holds a signal output from the pixel,
the pixel including:
a conversion unit that converts radiation or light into charges;
a charge storage unit that stores the charges;
a reset unit that resets the charges stored in the charge storage unit;
a first amplification unit that amplifies a signal based on the charges stored in the charge storage unit;
a second amplification unit that amplifies the signal amplified by the first amplification unit and outputs the signal such that the signal is held in the holding unit;
a first capacitor connected between an output portion of the first amplification unit and an input portion of the second amplification unit; and
a voltage control unit that controls a voltage at an input portion of the second amplification unit.

The holding unit may be arranged outside the pixel.

The imaging device may further include a signal line connected between each of the pixels and the holding unit, and
the holding unit may hold a signal output from the pixel via the signal line.

The imaging device may further include an ADC that converts the signal held by the holding unit into a digital signal.

The voltage control unit may control the input portion of the second amplification unit to a first voltage before reading the pixel signal based on the charge converted by the conversion unit, and
the ADC may convert a signal held by the holding unit after reading the pixel signal into a digital signal based on a second voltage signal corresponding to the first voltage, which is output from the second amplification unit before reading the pixel signal.

The ADC may further include:
a comparison unit that outputs a comparison result between the signal held by the holding unit and a reference signal;
a feedback unit that feeds back the comparison result from the comparison unit to an input portion of the comparison unit to which the reference signal is input before reading the pixel signal; and
a second capacitor connected between a reference signal generation unit that generates the reference signal and the input portion of the comparison unit, and
the second capacitor may hold a voltage difference between the second voltage and an initial voltage of the reference signal, the voltage level of which changes over time, before reading the pixel signal.

The feedback unit may be a switch that can be opened and closed, and is connected between the comparison result output portion of the comparison unit and the input portion of the comparison unit, and
the second capacitor may hold a voltage difference between the initial voltage and the second voltage before the pixel signal is read and when the switch changes from a closed state to an open state.

The holding unit and the ADC may be shared by a plurality of the pixels, and in parallel with the ADC converting a first pixel signal held by the holding unit into a digital signal, before reading the pixel signal based on the charge converted by the conversion unit in a second pixel, the voltage control unit may control the input portion of the second amplification unit to a first voltage, and the second amplification unit may output a second voltage signal corresponding to the first voltage.

The second pixel may be a pixel from which the pixel signal is read next to the first pixel.

A plurality of the pixels are arranged in a matrix, and
a plurality of the holding units that hold signals output from each of the plurality of pixels included in one pixel column in parallel may be provided.

In a period between a readout period in which a signal is read and a shutter period in which the first capacitor holds a voltage based on an operation of the reset unit and the first amplification unit, the reset unit may continue to reset the charge converted by the conversion unit and stored in the charge storage unit and the voltage control unit may continue to control the voltage at the input portion of the second amplification unit.

The pixel may further include:
an additional capacitance unit that adds capacitance to the charge storage unit; and
a switching unit that switches addition of capacitance by the additional capacitance unit.

### BRIEF DESCRIPTION OF DRAWINGS

FIG. 1 is a block diagram showing an example of a basic configuration of an imaging device.

FIG. 2 is a diagram showing an example of the configuration of an AD converter according to existing technology.

FIG. 3 is a circuit diagram showing an example of the configuration of a pixel according to a first embodiment.

FIG. 4 is a circuit diagram showing an example of the configuration of a sample-and-hold circuit and an AD converter according to the first embodiment.

FIG. 5 is a diagram showing an example of the overall configuration of the imaging device according to the first embodiment.

FIG. 6 is a diagram showing an example of the operation of the imaging device according to the first embodiment.

FIG. 7 is a timing chart showing an example of the operation of the imaging device according to the first embodiment.

FIG. 8 is a diagram illustrating an example of the operation of the imaging device according to a modification of the first embodiment.

FIG. 9 is a circuit diagram showing an example of the configuration of a pixel according to a second embodiment.

FIG. 10 is a circuit diagram showing an example of the configuration of a pixel according to a third embodiment.

### DESCRIPTION OF EMBODIMENTS

Hereinafter, embodiments of an imaging device will be described with reference to the drawings. Hereinafter, main components of the imaging device will be mainly described, but the imaging device may have components or functions that are not illustrated or described. The following description does not exclude components or functions that are not illustrated or described.

### (Configuration Example Applicable to Each Embodiment)

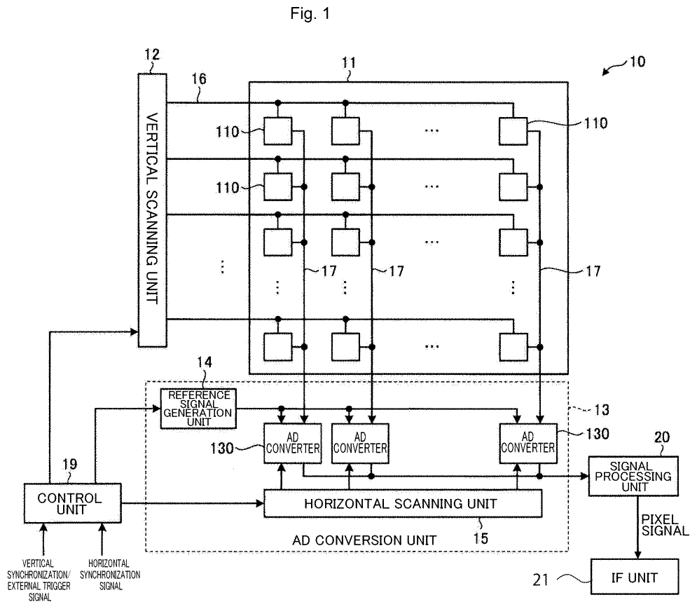

FIG. 1 is a block diagram showing a basic configuration example of an imaging device 10. In FIG. 1, the imaging device 10 includes a pixel array unit 11, a vertical scanning unit 12, an AD (Analog to Digital) conversion unit 13, a pixel signal line 16, a vertical signal line 17, a control unit 19, a signal processing unit 20, and an IF (Interface) unit 21.

The pixel array unit 11 includes a plurality of pixels 110 each having a photoelectric conversion unit using a photodiode, for example, which performs photoelectric conversion on received light. In the pixel array unit 11, the plurality of pixels 110 are arranged in a two-dimensional grid (matrix) in the horizontal direction (row direction) and the vertical direction (column direction). In the pixel array unit 11, the arrangement of pixels 110 in the row direction is called a line. One frame of image (image data) is formed by pixel signals read from a predetermined number of lines in this pixel array unit 11. For example, when one frame of image is formed with 3000 pixels×2000 lines, the pixel array unit 11 includes at least 2000 lines including at least 3000 pixels 110.

Further, in the pixel array unit 11, the pixel signal line 16 is connected to each row of each pixel 110, and the vertical signal line 17 is connected to each column of each pixel 110.

An end of the pixel signal line 16 that is not connected to the pixel array unit 11 is connected to the vertical scanning unit 12. The vertical scanning unit 12 transmits control signals such as drive pulses for reading pixel signals from pixels to the pixel array unit 11 via the pixel signal line 16 under the control of the control unit 19 described later. An end of the vertical signal line 17 that is not connected to the pixel array unit 11 is connected to the AD conversion unit 13. Pixel signals read from the pixels are transmitted to the AD converter 13 via the vertical signal line 17.

The AD conversion unit 13 includes an AD converter 130 (ADC, Analog to Digital Converter) provided for each vertical signal line 17, a reference signal generation unit 14, and a horizontal scanning unit 15. The AD converter 130 is a column AD converter that performs AD conversion processing on each column of the pixel array unit 11. The AD converter 130 performs AD conversion processing on the pixel signal supplied from the pixel 110 via the vertical signal line 17 to generate a digital value. A specific example of the configuration and processing of the AD converter 130 will be described later.

The AD converter 130 supplies the generated digital value to the signal processing unit 20. The signal processing unit 20 performs various types of digital signal processing, such as black level adjustment processing, column variation correction processing, and gradation correction processing, as necessary, and generates pixel signals (pixel data) based on digital signals. The IF unit 21 outputs a pixel signal based on a digital signal generated by the signal processing unit 20 to the outside of the imaging device 10.

Pixel signals based on digital signals output from the IF unit 21 are sequentially stored in, for example, a frame buffer outside the imaging device 10. When one frame of pixel signals is stored in the frame buffer, the stored pixel signals are read from the frame buffer as one frame of image data.

The reference signal generation unit 14 generates a ramp signal RAMP used by each AD converter 130 to convert a pixel signal into a digital value, based on the ADC control signal input from the control unit 19. The ramp signal RAMP is a signal whose level (voltage value) decreases or increases with a constant slope over time, or a signal whose level decreases or increases stepwise. The reference signal generation unit 14 supplies the generated ramp signal RAMP to each AD converter 130. The reference signal generation unit 14 is configured using, for example, a DA (Digital to Analog) conversion circuit.

The horizontal scanning unit 15 performs a selection scan to select each AD converter 130 in a predetermined order under the control of the control unit 19, thereby outputting each digital value temporarily held by each AD converter 130 sequentially to the signal processing unit 20. The horizontal scanning unit 15 is configured using, for example, a shift register or an address decoder.

The control unit 19 performs drive control of the vertical scanning unit 12, the AD conversion unit 13, the reference signal generation unit 14, the horizontal scanning unit 15, and the like. The control unit 19 generates various drive signals that serve as a reference for the operations of the vertical scanning unit 12, the AD conversion unit 13, the reference signal generation unit 14, and the horizontal scanning unit 15. The control unit 19 generates a control signal for the vertical scanning unit 12 to supply to each pixel 110 via the pixel signal line 16 based on, for example, a vertical synchronization signal or an external trigger signal and a horizontal synchronization signal supplied from the outside. The control unit 19 supplies the generated control signal to the vertical scanning unit 12.

The vertical scanning unit 12 supplies various signals including drive pulses to the pixel signal line 16 of the selected pixel row of the pixel array unit 11 to each pixel 110 line by line based on the control signal supplied from the control unit 19 and causes each pixel 110 to output a pixel signal to the vertical signal line 17. The vertical scanning unit 12 is configured using, for example, a shift register and an address decoder.

The imaging device 10 configured in this manner is a column AD type CMOS (Complementary Metal Oxide Semiconductor) image sensor in which AD converters 130 are arranged in each column.

### (AD Conversion Processing of Pixel Signals Using Existing Technology)

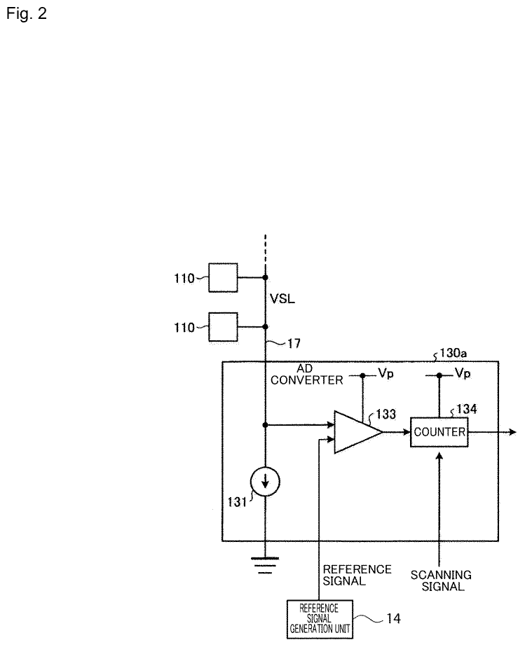

Prior to describing the operation of the AD converter 130 according to the embodiment, AD conversion processing by the column AD converter will be described for ease of understanding. FIG. 2 is a diagram illustrating an example of the configuration of an AD converter 130a according to existing technology as a column AD converter in FIG. 1. In FIG. 2, the AD converter 130a includes a current source 131, a comparator 133, and a counter 134. The comparator 133 and the counter 134 each operate with power supplied from a power supply line Vp.

The pixel signal read from the pixel 110 is drawn into the current source 131 from the vertical signal line 17, supplied to the AD converter 130a, and input to one input terminal of the comparator 133.

The reference signal generation unit 14 inputs the reference signal to the other input terminal of the comparator 133. For example, the reference signal generation unit 14 generates, as the ramp signal RAMP, the above-mentioned digital signal whose value decreases stepwise with time (clock). The reference signal generation unit 14 converts this ramp signal RAMP into an analog signal and inputs it to the other input terminal of the comparator 133. That is, a signal whose voltage value changes (decreases) in a stepwise manner according to the clock is input as a reference signal to the other input terminal of the comparator 133.

The comparator 133 holds the pixel signal input to one input terminal, and compares the level of the held pixel signal with the level of the ramp signal RAMP input to the other input terminal. The comparator 133 outputs a high-state difference signal when the level of the ramp signal RAMP is higher than the level of the held pixel signal. On the other hand, when the level of the ramp signal RAMP becomes equal to or lower than the level of the held pixel signal, the comparator 133 inverts its output and outputs a low-state difference signal. The difference signal output from the comparator 133 is supplied to the counter 134. Note that the level of the ramp signal RAMP is reset to a predetermined value after the output of the comparator 133 is inverted.

The counter 134 performs counting based on the difference signal output from the comparator 133, for example, according to a common clock with the reference signal generation unit 14. More specifically, the counter 134 counts the time (clock) from when the level of the ramp signal RAMP starts dropping until it reaches a level below the pixel signal, according to the difference signal input from the comparator 133 and outputs a count value (digital value) obtained by this counting to the signal processing unit 20.

### First Embodiment

### (Configuration)

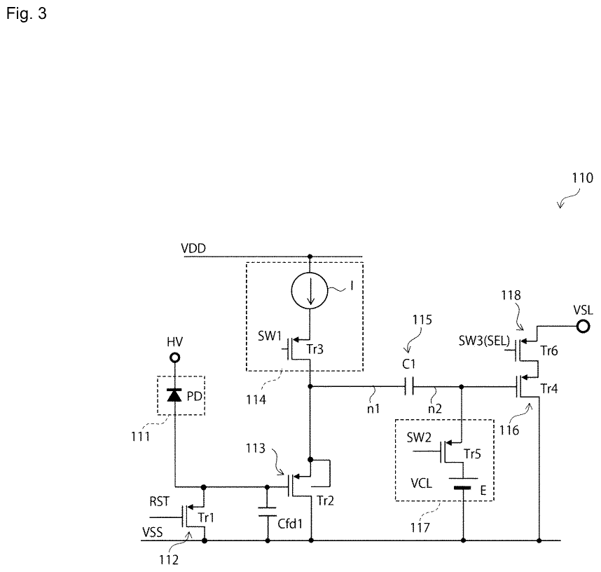

FIG. 3 is a circuit diagram showing an example of the configuration of the pixel 110 according to the first embodiment.

The pixel 110 includes a conversion unit 111, a charge storage unit Cfd1, a reset unit 112, a first amplification unit 113, a current control unit 114, a noise storage unit 115, a second amplification unit 116, a voltage control unit 117, and a selection unit 118.

The conversion unit 111 converts radiation or light into charges. The conversion unit 111 includes a photoelectric conversion unit PD. The photoelectric conversion unit PD is, for example, a photodiode. When detecting radiation, the conversion unit 111 further includes a scintillator (not shown) that converts the wavelength of radiation such as a-rays, B-rays, y-rays, or X-rays into light (for example, visible light). In this case, the imaging device 10 is used, for example, in a radiation imaging system such as an X-ray device or a CT (Computed Tomography) device. The cathode of the photoelectric conversion unit PD is connected to a reference voltage node (not shown). The anode of the photoelectric conversion unit PD is electrically connected to the charge storage unit Cfd1.

The charge storage unit Cfd1 stores the charges supplied from the conversion unit 111. The charge storage unit Cfd1 generates a voltage according to the amount of stored charge. The charge storage unit Cfd1 is connected between the anode of the photoelectric conversion unit PD and the reference voltage node VSS.

The reset unit 112 resets the charges stored in the charge storage unit Cfd1. The reset unit 112 includes a reset transistor Tr1 whose gate is supplied with a control signal RST. In the example shown in FIG. 3, where the reset transistor Tr1 is connected between the anode of the photoelectric conversion unit PD and the reference voltage node VSS, the reset transistor Tr1 is connected in parallel with the charge storage unit Cfd1. When the reset transistor Tr1 is turned on by the control signal RST, the charges stored in the charge storage unit Cfd1 are discharged to the ground node GND. The reset transistor Tr1 is, for example, a P-type MOS transistor.

The first amplification unit 113 amplifies a signal (voltage) based on the charges stored in the charge storage unit Cfd1. The first amplification unit 113 functions as part of a source follower circuit. The first amplification unit 113 includes a first amplification transistor Tr2. The first amplification transistor Tr2 is connected between the current control unit 114 and the reference voltage node VSS. The first amplification transistor Tr2 is, for example, a P-type MOS transistor.

The current control unit 114 controls the current flowing through the first amplification unit 113. The current control unit 114 functions as part of a source follower circuit. The current control unit 114 includes a current source I and a current control transistor Tr3 whose gate is supplied with a control signal SW1. The current source I and the current control transistor Tr3 are connected in series between the reference voltage node VDD and the first amplification transistor Tr2. The current control transistor Tr3 is, for example, a P-type MOS transistor.

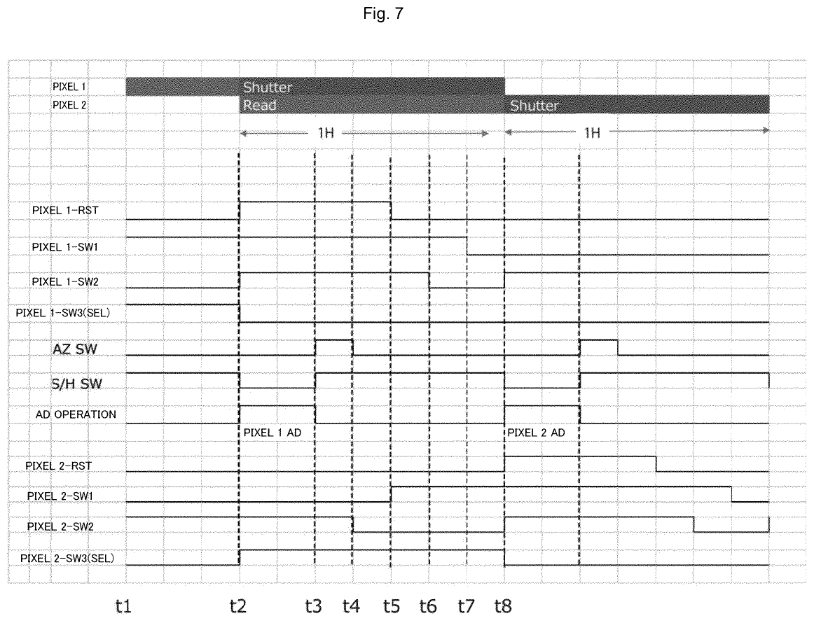

The noise storage unit 115 stores reset noise (kTC noise) and the offset of the first amplification transistor Tr2. The noise storage unit 115 has a clamp capacitance C1 (first capacitor). The clamp capacitance C1 is connected between the output portion of the first amplification unit 113 and the input portion of the second amplification unit 116. As will be described later with reference to FIG. 7, the clamp capacitance C1 can suppress the effects of kTC noise, the offset of the first amplification transistor Tr2, and the like.

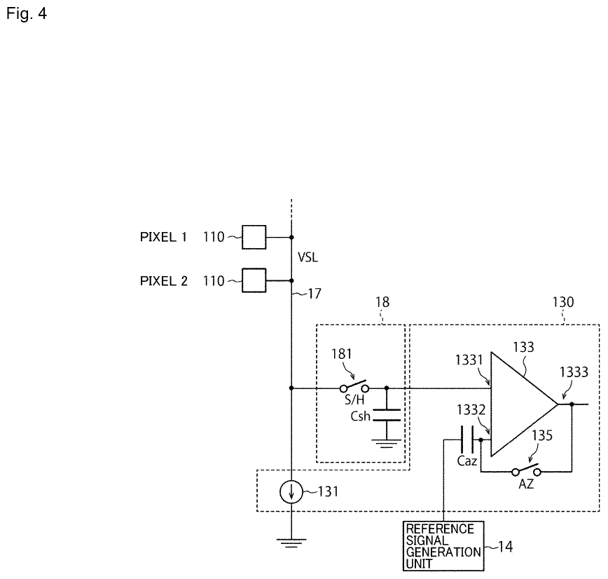

The second amplification unit 116 amplifies the signal amplified by the first amplification unit 113 and outputs the amplified signal such that the amplified signal is held in a sample-and-hold circuit 18. Note that the sample-and-hold circuit 18 will be described later with reference to FIG. 4. The second amplification unit 116 includes a second amplification transistor Tr4. The second amplification transistor Tr4 is, for example, a P-type MOS transistor.

The voltage control unit 117 controls the voltage at the input portion of the second amplification unit 116 and the second end n2 of the clamp capacitance C1. The voltage control unit 117 includes a voltage source E and a voltage control transistor Tr5 whose gate is supplied with a control signal SW2. The voltage source E and the voltage control transistor Tr5 are connected in series between the input portion of the second amplification unit 116, the second end n2 of the clamp capacitance C1, and the reference voltage node VSS. The voltage source E supplies a predetermined clamp voltage VCL. The voltage control transistor Tr5 is, for example, a P-type MOS transistor.

The selection unit 118 selects the pixel 110 to output a signal to the vertical signal line 17. The selection unit 118 includes a selection transistor Tr6 whose gate is supplied with a control signal SW3 (SEL). The selection unit 118 is connected between the second amplification unit 116 and the vertical signal line 17 (VSL). The selection transistor Tr6 is, for example, a P-type MOS transistor.

FIG. 4 is a circuit diagram showing an example of the configuration of the sample-and-hold circuit 18 and the AD converter 130 according to the first embodiment. FIG. 3 shows a part of the AD converter 130 from the pixel 110 to the comparator 133.

The imaging device 10 further includes the sample-and-hold circuit 18 (holding unit).

The sample-and-hold circuit 18 is arranged outside the pixel 110 and holds the signal output from the pixel 110. More specifically, the sample-and-hold circuit 18 holds the signal output from the pixel 110 via the vertical signal line 17. The vertical signal line 17 is arranged between each pixel 110 and the sample-and-hold circuit 18. Further, the sample-and-hold circuit 18 is connected between the vertical signal line 17 and the AD converter 130. Further, the sample-and-hold circuit 18 is arranged for each AD converter 130. That is, the sample-and-hold circuit 18 is shared by the plurality of pixels 110, similarly to the AD converter 130.

The sample-and-hold circuit 18 includes a switch 181 (switching unit) and a capacitor Csh.

The switch 181 is a switch that opens and closes based on the control signal S/H. The switch 181 is connected between the vertical signal line 17 and the first input portion 1331 of the comparator 133. The control signal S/H is supplied from the vertical scanning unit 12 via the pixel signal line 16 shown in FIG. 1.

The capacitor Csh is connected between the first input portion 1331 of the comparator 133 and the switch 181, and the reference voltage node VSS (ground node). The capacitor Csh receives a signal output from the pixel 110 when the switch 181 is on (closed), and holds the signal when the switch 181 is off (open).

The AD converter 130 converts the signal held by the sample-and-hold circuit 18 into a digital signal. The AD converter 130 is, for example, a single slope-type AD converter.

The AD converter 130 further includes a switch 135 (feedback unit) and a capacitor Caz (second capacitor). The switch 135 and the capacitor Caz auto-zero the comparator 133. In this way, as will be described later with reference to FIG. 7, the speed of AD conversion by the AD converter 130 can be increased.

The switch 135 is a switch that opens and closes based on the control signal AZ. The switch 135 is connected between a comparison result output portion 1333 of the comparator 133 and a second input portion 1332 of the comparator 133. The control signal AZ is supplied from the vertical scanning unit 12 via the pixel signal line 16 shown in FIG. 1.

When the switch 135 is turned on, the output signal of the comparator 133 is fed back to the second input portion 1332, and auto-zero, which will be described later, is executed.

The capacitor Caz holds voltage by auto-zero. The capacitor Caz is connected between the reference signal generation unit 14 (DA converter), the second input portion 1332 of the comparator 133, and the switch 135. The capacitor Caz holds a voltage corresponding to the threshold voltage Vth2 of the second amplification transistor Tr4 by auto-zero, which will be described later.

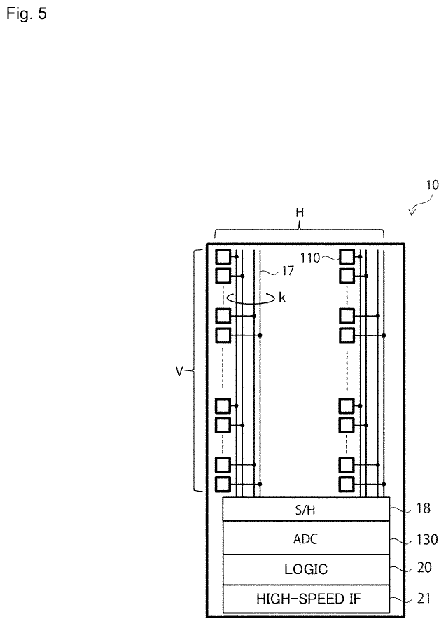

FIG. 5 is a diagram showing an example of the overall configuration of the imaging device 10 according to the first embodiment. In the example shown in FIG. 5, V pixels 110 are arranged in the column direction (vertical direction) and H pixels 110 are arranged in the row direction.

If one vertical signal line 17 is provided in one pixel column, AD conversion of the output signals of all pixels is completed by performing AD conversion V times.

On the other hand, in the example shown in FIG. 5, a plurality of (for example, arbitrary k) vertical signal lines 17 are provided in one pixel column. The V pixels 110 are divided into V/k pixels 110 per group. That is, the signals output from the k pixels 110 are divided and passed through each of the k vertical signal lines 17. In this case, AD conversion of the output signals of all pixels is completed by performing AD conversion V/k times. That is, AD conversion of k rows of pixels 110 is performed in parallel. Therefore, by providing a plurality of output lines from the pixel 110, AD conversion of the entire pixel 110 can be made faster.

Further, a number of sample-and-hold circuits 18 and AD converters 130 corresponding to the k vertical signal lines 17 are provided. That is, the imaging device 10 includes a plurality of sample-and-hold circuits 18 that hold signals output from each of the plurality of pixels 110 included in one pixel column in parallel. Therefore, the imaging device 10 is provided with H×k sample-and-hold circuits 18 and AD converters 130.

### (Operation)

Next, the operation of the imaging device 10 will be described.

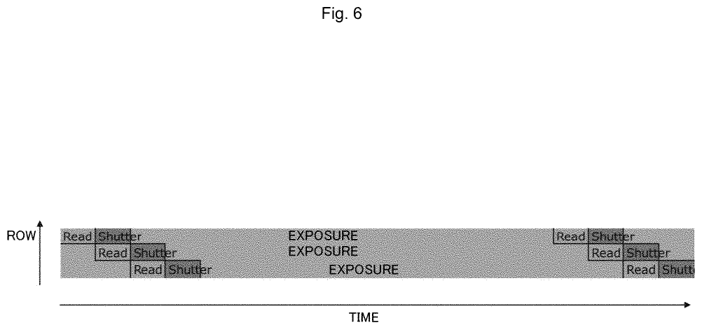

FIG. 6 is a diagram illustrating an example of the operation of the imaging device 10 according to the first embodiment. The vertical axis in FIG. 6 indicates pixel rows. The horizontal axis in FIG. 6 indicates time.

In the example shown in FIG. 6, one frame includes a shutter mode (Shutter), a read mode (Read), and an exposure period. Further, the imaging device 10 operates using a rolling shutter method. Therefore, the start of exposure and the readout of signals are performed sequentially for each pixel row.

The shutter mode is an operation mode in which a voltage of a noise component such as kTC noise caused by the reset transistor Tr1 is stored in the clamp capacitance C1. As shown in FIG. 6, exposure is performed after the shutter mode. During the exposure period, the charges converted by the conversion unit 111 are stored in the charge storage unit Cfd1. As a result, the voltage of the charge storage unit Cfd1 increases by the signal voltage Vs. The signal voltage Vs is the voltage of the pixel signal. After the exposure period, a read mode is executed. The read mode is an operation mode in which a signal at a clamp level (clamp voltage VCL) serving as a reference for AD conversion is read, and a signal level (signal voltage Vs) is read.

FIG. 7 is a timing chart showing an example of the operation of the imaging device 10 according to the first embodiment. Note that the high level of the control signal in FIG. 7 indicates that the transistor and switch are on. Therefore, the actual high level of the control signal and the on-state of the transistor may be different.

FIG. 7 shows the operations of pixel 1 and pixel 2 arranged in two adjacent pixel rows, the sample-and-hold circuit 18, and the AD converter 130. Pixel 2 (second pixel) is a pixel whose pixel signal is read next to pixel 1 (first pixel). Similarly to FIG. 6, while pixel 1 operates in the shutter mode, pixel 2 operates in the read mode.

### (Shutter Mode and Read Mode)

The shutter mode will be described below with reference to the period from time t2 to time t8 of pixel 1 in FIG. 7. Thereafter, the read mode will be described with reference to the period from time t2 to time t8 of pixel 2 in FIG. 7.

At time t1, during the read mode of pixel 1, the control signal SW1 is high. As a result, as shown in FIG. 3, the current control transistor Tr3 is in an on-state, and the current source I operates.

First, at time t2, the control signals RST and SW2 become high. In this way, the reset transistor Tr1 and the voltage control transistor Tr5 are turned on. By turning on the reset transistor Tr1, the charges stored in the charge storage unit Cfd1 are reset. By turning on the voltage control transistor Tr5, the second end n2 of the clamp capacitance C1 is fixed to the clamp voltage VCL.

Next, at time t5, the control signal RST becomes low. In this way, the reset transistor Tr1 is turned off. Further, noise caused by the reset transistor Tr1 being turned off is stored in the charge storage unit Cfd1. The voltage of the charge storage unit Cfd1 increases in accordance with the kTC noise.

Next, at time t6, the control signal SW2 becomes low. In this way, the voltage control transistor Tr5 is turned on. The voltage level of the first end n1 of the clamp capacitance C1 is the sum (Vn+Vth1) of the voltage (noise voltage Vn) according to the kTC noise and the voltage (threshold voltage Vth1) according to the offset of the first amplification transistor Tr2. Note that the offset of the first amplification transistor Tr2 is also the gate-source voltage. In this way, the clamp capacitance C1 stores the noise voltage of the kTC noise and the threshold voltage Vth1 of the first amplification transistor Tr2. Further, the voltage level at the second end n2 of the clamp capacitance C1 is the clamp voltage VCL. Therefore, the voltage across the clamp capacitance C1 is Vn+Vth-VCL.

Next, at time t7, the control signal SW1 becomes low. As a result, the current control transistor Tr3 is turned off, and the current source I stops operating. Further, the source (output portion) of the first amplification transistor Tr2 becomes in a high impedance state. Therefore, the noise voltage is stored in the clamp capacitance C1.

Next, at time t8, the control signal SW2 becomes high. In this way, the voltage control transistor Tr5 is turned on. The voltage at the second end n2 of the clamp capacitance C1 is fixed to the clamp voltage VCL. This is because if both ends of the clamp capacitance C1 enter a high impedance state, the voltage held in the clamp capacitance C1 may become unstable.

Next, the read mode will be described with reference to pixel 2.

The charge storage unit Cfd1 of the pixel 2 stores charges converted by the conversion unit 111 during the exposure period up to time t2. Therefore, the gate voltage of the first amplification transistor Tr2, which is not operating, has increased by the signal voltage Vs.

At time t1, during the exposure period of pixel 2, the control signal SW2 is high. In this way, as shown in FIG. 3, the voltage control transistor Tr5 is in the on-state.

First, at time t2, the control signal SW3 (SEL) becomes high. In this way, the selection transistor Tr6 is turned on. Since the voltage control transistor Tr5 is in the on-state, the clamp voltage VCL, which is the clamp level, is output to the vertical signal line 17 (VSL). Note that since the control signal SW1 is low and the current control transistor Tr3 is in an off-state, the first amplification transistor Tr2 is not operating.

That is, in the pixel 2, before reading a pixel signal based on the charge converted by the conversion unit 111, the voltage control unit 117 controls the input portion of the second amplification unit 116 to the first voltage (clamp voltage VCL), and the second amplification unit 116 outputs a signal of a second voltage (VCL+Vth2) according to the clamp voltage VCL. As a result, the vertical signal line 17 is charged.

Next, at time t4, the control signal SW2 becomes low. In this way, the voltage control transistor Tr5 is turned off. Therefore, the fixation of the clamp voltage level is released.

Next, at time t5, the control signal SW1 becomes high. As a result, the current control transistor Tr3 is turned on, and the current source I operates. By operating the first amplification transistor Tr2 functioning as a part of the source follower circuit, a signal voltage Vs is applied to the first end n1 of the clamp capacitance C1. The voltage at the first end n1 is Vs+Vn+Vth. As described in the shutter mode, the voltage across the clamp capacitance C1 is Vn+Vth−VCL, so the voltage at the second end n2 is Vs+VCL. Therefore, on the second end n2 side, the influence of the noise components of the noise voltage Vn and the threshold voltage Vth1 is suppressed. This is a clamping operation that clamps the noise component and outputs the subsequent voltage change in the charge storage unit Cfd1 as a signal component. That is, due to capacitive coupling, the voltage at the second end cl2 increases by the signal voltage Vs. Further, since the selection transistor Tr6 is in the on-state, a voltage of Vs+VCL including the signal voltage Vs is output to the vertical signal line 17. More specifically, a voltage of Vs+VCL+Vth2 including the offset Vth2 of the second amplification transistor Tr4 is output to the vertical signal line 17.

Next, at time t8, the control signal SW3 becomes low. As a result, the selection transistor Tr6 is turned off. Therefore, the output of the signal to the vertical signal line 17 is stopped.

### (Sample-and-Hold Circuit and AD Converter)

Next, the operation of the sample-and-hold circuit 18 and the AD converter 130 will be described with reference to FIG. 7.

First, at time t1, pixel 1 is in the read mode. Pixel 1 operates similarly to the read mode of pixel 2 described above. As described with respect to time t5 of pixel 2, pixel 1 at time t1 outputs a voltage of Vs+VCL+Vth2, including the signal voltage Vs, to the vertical signal line 17.

The control signal S/H at time t1 is high. As a result, the switch 181 is in the on-state. Therefore, the voltage of Vs+VCL+Vth2 is input to the capacitor Csh.

At time t2, the control signal S/H becomes low. As a result, the switch 181 shown in FIG. 4 is turned off, and the voltage of Vs+VCL+Vth2 is held in the capacitor Csh. Since the control signal SW3 of the pixel 1 also becomes low, the pixel 1, the vertical signal line 17, and the first input portion 1331 of the comparator 133 are electrically disconnected from each other.

Furthermore, at time t2, the AD converter 130 starts AD operation of the signal held by the sample-and-hold circuit 18. In this way, the signal of pixel 1 is AD-converted.

Here, as described above, the pixel 2 at time t2 outputs the clamp voltage VCL, which is the clamp level, to the vertical signal line 17 (VSL). Since the switch 181 is in the off-state, the vertical signal line 17 and the AD converter 130 are electrically disconnected. However, the pixel 2 can charge the vertical signal line 17. It takes time for the vertical signal line 17 to reach a desired voltage due to its long wiring length and parasitic capacitance. By turning on the selection transistor Tr6 of pixel 2 at time t2, which is earlier than time t3, the output of the signal of pixel 2 (clamp voltage VCL) to the AD converter 130 can be completed shorter in time after the AD conversion of the signal of the first pixel.

In this way, AD conversion of the signal of pixel 1 and charging of the vertical signal line 17 by pixel 2 are performed in parallel. In other words, the time for AD conversion of pixel 1 and the settling time (preparation for signal readout) for the clamp level of pixel 2 can be overlapped, and the time for one horizontal line (1H) can be further shortened.

Next, at time t3, the AD converter 130 ends the AD conversion operation of the signal of pixel 1. Further, at time t3, the control signal S/H becomes high. As a result, the switch 181 is turned on. As a result, the clamp voltage VCL of the pixel 2 is input to the sample-and-hold circuit 18. As shown in FIG. 7, the switch 181 of the sample-and-hold circuit 18 remains on from time t3 to time t8, and turns off at time t8. In this way, the signal of pixel 2 is held in the sample-and-hold circuit 18.

### (Auto-Zero of Comparator)

Next, the auto-zero operation of the comparator 133 will be described. Auto-zero is performed during the period from time t3 to time t4 in FIG. 7.

The comparator 133 shown in FIG. 4 performs AD conversion based on a comparison between the ramp signal RAMP input from the second input portion 1332 and the signal input from the first input portion 1331. The voltage of the ramp signal RAMP changes (for example, increases) from the initial voltage over time. When the voltage of the ramp signal RAMP matches the voltage input to the first input portion 1331 of the comparator 133, it returns to the initial voltage again. The voltage of the ramp signal RAMP repeats the above changes for each pixel 110.

Generally, transistor performance, that is, the threshold voltage of a transistor, varies depending on the process, power supply voltage, temperature, and the like. Due to variations in the threshold voltage Vth2 of the second amplification transistor Tr4, and the like, the voltage of the signal output from the pixel 110 also varies. Furthermore, since the threshold voltage of the transistor varies due to radiation, the influence of variations in the threshold voltage Vth2 of the second amplification transistor Tr4 becomes even greater. In this case, the DA converter of the reference signal generation unit 14 needs to widen the sweep range of the ramp signal RAMP. However, widening the sweep range leads to a longer AD conversion time.

Therefore, the auto-zero of the comparator 133 suppresses widening of the sweep range and suppresses the lengthening of the AD conversion time.

First, at time t3 shown in FIG. 7, the control signals SW2 and SW3 are high. As a result, the voltage control transistor Tr5 and the selection transistor Tr6 of the pixel 2 are in the on-state. That is, the voltage control unit 117 controls the input portion of the second amplification unit 116 to the first voltage (clamp voltage VCL) before reading the pixel signal based on the charge converted by the conversion unit 111. As a result, the clamp voltage VCL, which is a fixed voltage, is input to the second amplification transistor Tr4. Further, a voltage (VCL+Vth2) that is the sum of the clamp voltage VCL and the threshold voltage Vth2 of the second amplification transistor Tr4 is output from the pixel 110.

Furthermore, at time t3, the control signals AZ and S/H become high. As a result, the switches 135 and 181 are turned on. When the switch 181 is turned on, a voltage (VCL+Vth2) that is the sum of the clamp voltage VCL and the threshold voltage Vth2 of the second amplification transistor Tr4 is input to the first input portion 1331 of the comparator 133. Further, when the switch 135 is turned on, the output signal of the comparator 133 is fed back to the second input portion 1332. That is, the switch 135 feeds back the comparison result of the comparator 133 to the second input portion 1332 before reading the pixel signal. Furthermore, before reading the pixel signal, the capacitor Caz holds the voltage difference between the initial voltage of the reference signal whose voltage level changes over time and the sum of the second voltage (VCL+Vth2) and the offset of the comparator 133. More specifically, before the pixel signal is read, and when the switch 135 changes from the closed state to the open state, the capacitor Caz holds the voltage difference between the initial voltage and the sum of the second voltage (VCL+Vth2), and the offset of the comparator 133. That is, the capacitor Caz holds the unnecessary voltage so that the reference signal and the second voltage (VCL+Vth2) are balanced.

The voltage held in the capacitor Caz allows the sweep start voltage of the ramp signal RAMP to be close to the above sum voltage (VCL+Vth2). In this way, the sweep range of the reference signal generation unit 14 can be narrowed, and the time required for AD conversion can be further shortened. As a result, AD conversion by the AD converter 130 can be made faster.

Further, a voltage corresponding to the threshold voltage Vth2 of the second amplification transistor Tr4 is held in the capacitor Caz. In this way, it is possible to suppress the influence of variations in the threshold voltage Vth2 of the second amplification transistor Tr4 and fluctuations in the threshold voltage Vth2 of the second amplification transistor Tr4 due to radiation.

Next, at time t4, the control signal SW2 and the control signal AZ of the pixel 2 become low. In this way, the voltage control transistor Tr5 and the switch 135 are turned off. Therefore, auto-zero is completed.

Next, at time t8, AD conversion of pixel 2 is performed. That is, the AD converter 130 converts the signal to be held by the sample-and-hold circuit 18 after reading the pixel signal into a digital signal based on the signal of the second voltage (VCL+Vth2) corresponding to the clamp voltage VCL, which is output from the second amplification unit 116 before reading the pixel signal.

As described above, according to the first embodiment, the sample-and-hold circuit 18 is arranged outside the pixel 110. This allows the pixel size to be further reduced.

Generally, a circuit for reducing reset noise (kTC noise) and a circuit for correcting the offset of an amplification transistor may be arranged within a pixel. However, in this case, the number of transistors is large, making it difficult to reduce the pixel size.

In contrast, in the first embodiment, the number of elements such as transistors in the pixel 110 can be reduced, and the pixel size can be further reduced.

Further, the clamp capacitance C1 is provided within the pixel 110. In this way, the noise voltage Vn due to kTC noise within the pixel 1 can be reduced.

Moreover, the offset (threshold voltage Vth1) of the first amplification transistor Tr2 can be suppressed by the clamp capacitance C1. The threshold voltage Vth1 of the first amplification transistor Tr2 may vary depending on radiation. However, since the effect of the threshold voltage Vth1 can be suppressed by the clamp operation, even if the threshold voltage Vth1 changes due to radiation, the dynamic range of the second amplification unit 116 is not affected.

Furthermore, the auto-zero described above can suppress the influence of variations in the threshold voltage Vth2 of the second amplification transistor Tr4 and fluctuations in the threshold voltage Vth2 due to radiation. As a result, AD conversion by the AD converter 130 can be made faster.

Further, the sample-and-hold circuit 18 is arranged before the comparator 133. As a result, as shown from time t2 to time t3 in FIG. 7, AD conversion of a certain pixel 110 (pixel 1) and offset (clamp voltage VCL) settling of the pixel 110 (pixel 2) that will undergo AD conversion next can be executed in parallel. As a result, the frame rate can be further increased.

Note that the reset transistor Tr1, first amplification transistor Tr2, current control transistor Tr3, second amplification transistor Tr4, voltage control transistor Tr5, and selection transistor Tr6 are not limited to P-type MOS transistors, but may be N-type MOS transistors. Moreover, it is not limited to a MOS transistor, and may be any other type of transistor.

### Modification of First Embodiment

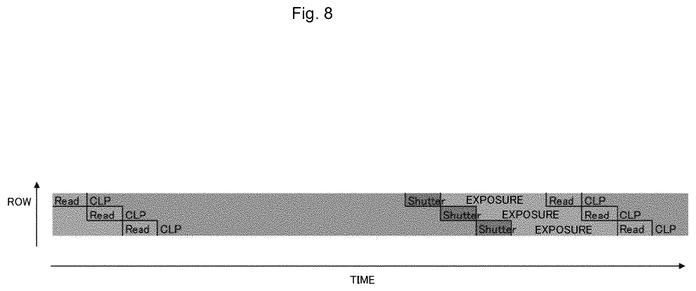

FIG. 8 is a diagram illustrating an example of the operation of the imaging device 10 according to a modification of the first embodiment. The modification of the first embodiment has a shorter exposure period than the first embodiment.

In the example shown in FIG. 6 of the first embodiment, the exposure period is set to be as long as possible with respect to the set frame rate. However, for example, when the subject is bright, the exposure period may be set short as shown in FIG. 8.

In the example shown in FIG. 8, a clamp mode (CLP) is included between the read mode and shutter mode in one frame. The clamp mode is an operation mode in which charges converted by the conversion unit 111 are discharged without being stored in the charge storage unit Cfd1.

In the clamp mode, the reset transistor Tr1 is in an on-state. That is, in the clamp mode, the reset unit 112 continues to reset the charge storage unit Cfd1. As a result, the charge converted by the conversion unit 111 continues to be discharged to the reference voltage node VSS via the reset transistor Tr1. Further, in the clamp mode, the current control transistor Tr3 and the selection transistor Tr6 are in an off-state, and the voltage control transistor Tr5 is in an on-state. That is, in the clamp mode, the voltage control unit 117 continues to control the voltage at the input portion of the second amplification unit 116.

As in the modification of the first embodiment, the exposure period may be changed. Also in this case, effects similar to those of the first embodiment can be obtained.

### Second Embodiment

### (Configuration)

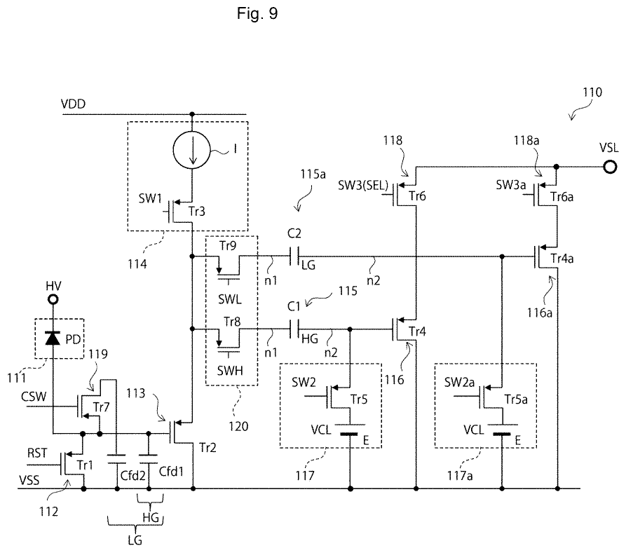

FIG. 9 is a circuit diagram showing an example of the configuration of the pixel 110 according to the second embodiment. The second embodiment differs from the first embodiment in that signals are read with high sensitivity and low sensitivity.

The pixel 110 further includes an additional capacitance unit Cfd2, a capacitance switching unit 119, a noise storage unit 115a, a clamp switching unit 120, a second amplification unit 116a, a voltage control unit 117a, and a selection unit 118a.

The additional capacitance unit Cfd2 adds capacitance to the charge storage unit Cfd1. The additional capacitance unit Cfd2 stores the charge supplied from the conversion unit 111, similarly to the charge storage unit Cfd1. The additional capacitance unit Cfd2 is connected in parallel with the charge storage unit Cfd1.

The capacitance switching unit 119 switches the addition of capacitance by the additional capacitance unit Cfd2. The capacitance switching unit 119 is a switch that can change the sensitivity of the pixel 110. The capacitance switching unit 119 includes a capacitance switching transistor Tr7 to which a control signal CSW is input to the gate. The capacitance switching transistor Tr7 is, for example, a P-type MOS transistor.

When the capacitance switching transistor Tr7 is in the off-state, the additional capacitance unit Cfd2 is electrically disconnected from the charge storage unit Cfd1. Therefore, no charge is stored in the additional capacitance unit Cfd2 during the exposure period. On the other hand, when the capacitance switching transistor Tr7 is on, the additional capacitance unit Cfd2 is electrically connected to the charge storage unit Cfd1. By electrically connecting the additional capacitance unit Cfd2 to the charge storage unit Cfd1, a capacitance can be added to the charge storage unit Cfd1. As a result, the sensitivity of the pixel 110 can be reduced. Hereinafter, the case where the capacitance switching transistor Tr7 is in the off-state will be referred to as high gain (HG). Further, the case where the capacitance switching transistor Tr7 is in the on-state is referred to as low gain (LG).

In the high gain state, the noise storage unit 115, second amplification unit 116, voltage control unit 117, and selection unit 118 shown in FIG. 9 operate in the same manner as in the first embodiment. In the low gain state, the noise storage unit 115a, the second amplification unit 116a, the voltage control unit 117a, and the selection unit 118a operate almost the same way as the noise storage unit 115, the second amplification unit 116, the voltage control unit 117, and the selection unit 118 in the high gain state, respectively.

The clamp switching unit 120 includes a high-gain transistor Tr8 whose gate is supplied with a control signal SWH, and a low-gain transistor Tr9 whose gate is supplied with a control signal SWH. The high-gain transistor Tr8 is connected between the first amplification transistor Tr2 and the noise storage unit 115, which is the clamp capacitance C1. The low-gain transistor Tr9 is connected between the first amplification transistor Tr2 and the noise storage unit 115a, which is the clamp capacitance C2.

In the high gain state, the high-gain transistor Tr8 is turned on and the low-gain transistor Tr9 is turned off. In the low gain state, the high-gain transistor Tr8 is turned off and the low-gain transistor Tr9 is turned on.

The noise storage unit 115a has a clamp capacitance C2. In the low gain state, the clamp capacitance C2 functions almost similarly to the clamp capacitance C1.

The second amplification unit 116a includes a second amplification transistor Tr4a. In the low gain state, the second amplification transistor Tr4a functions substantially in the same way as the second amplification transistor Tr4.

The voltage control unit 117a includes a voltage source E and a voltage control transistor Tr5a whose gate is supplied with a control signal SW2a. In the low gain state, the voltage control transistor Tr5a functions substantially in the same way as the voltage control transistor Tr5.

The selection unit 118a includes a selection transistor Tr6a whose gate is supplied with a control signal SW3a. In the low gain state, the selection transistor Tr6a functions almost in the same way as the selection transistor Tr6.

### (Operation)

Next, the operation of the imaging device 10 will be described. First, the shutter mode will be described with reference to FIG. 7. After that, the read mode and clamp mode will be described.

First, similarly to time t2, the control signals RST, CSW, SWL, and SW2a become high. As a result, the capacitance switching transistor Tr7, the low-gain transistor Tr9, and the voltage control transistor 5a are turned on. Since the capacitance switching transistor Tr7 is turned on, the pixel 110 operates in the low gain state.

Next, similarly to time t5, the control signal RST becomes low. In this way, the reset transistor Tr1 is turned off.

Next, similarly to time t6, the control signal SW2a becomes low. In this way, the voltage control transistor Tr5a is turned off. Therefore, the low gain-side clamp capacitance C2 stores the noise voltage of the kTC noise and the threshold voltage Vth1 of the first amplification transistor Tr2.

Next, the control signal SWL becomes low. As a result, the low-gain transistor Tr9 is turned off.

Next, the control signals SWH and SW2 become high. As a result, the high-gain transistor Tr8 and the voltage control transistor Tr5 are turned on.

The control signal CSW then becomes low. As a result, the capacitance switching transistor Tr7 is turned off. Since the capacitance switching transistor Tr7 is turned off, the pixel 110 operates in the high gain state.

Next, similarly to time t6, the control signal SW2 becomes low. In this way, the voltage control transistor Tr5 is turned off. Therefore, the high gain-side clamp capacitance C1 stores the noise voltage of the kTC noise and the threshold voltage Vth1 of the first amplification transistor Tr2.

The control signal SWH then becomes low. As a result, the high-gain transistor Tr8 is turned off.

Next, similarly to time t7, the control signal SW1 becomes low. As a result, the current control transistor Tr3 is turned off, and the current source I stops operating.

Next, similarly to time t8, the control signal SW2 becomes high. Further, the control signal SW2a becomes high. In this way, the voltage control transistors Tr5 and Tr5a are turned on. Therefore, the voltage at the second end n2 of the clamp capacitances C1 and C2 is fixed to the clamp voltage VCL.

Next, the read mode will be described.

First, similarly to time t2, the control signal SW3 (SEL) becomes high. In this way, the selection transistor Tr6 is turned on. Since the voltage control transistor Tr5 is in the on-state, the clamp voltage VCL, which is a high-gain clamp level, is output to the vertical signal line 17 (VSL).

Next, similarly to time t4, the control signal SW2 becomes low. In this way, the voltage control transistor Tr5 is turned off.

Next, similarly to time t5, the control signal SW1 becomes high. As a result, the current control transistor Tr3 is turned on, and the current source I operates.

Next, the control signal SWH becomes high. As a result, the high-gain transistor Tr8 is turned on. Since the selection transistor Tr6 is in the on-state, a voltage of Vs+VCL+Vth2 including the high gain signal voltage Vs is output to the vertical signal line 17.

Next, similarly to time t8, the control signals SW3 and SWH become low. As a result, the selection transistor Tr6 and the high-gain transistor Tr8 are turned off. Further, the control signal CSW becomes high. As a result, the capacitance switching transistor Tr7 is turned on. Since the capacitance switching transistor Tr7 is turned on, the pixel 110 operates in the low gain state.

Next, similarly to time t2, the control signal SW3a becomes high. In this way, the selection transistor Tr6a is turned on. Since the voltage control transistor Tr5a is in the on-state, the clamp voltage VCL, which is a low gain clamp level, is output to the vertical signal line 17 (VSL).

Next, similarly to time t4, the control signal SW2a becomes low. In this way, the voltage control transistor Tr5a is turned off.

Next, the control signal SWL becomes high. In this way, the low-gain transistor Tr9 is turned on. Since the selection transistor Tr6a is in the on-state, a voltage of Vs+VCL+Vth2 including the low gain signal voltage Vs is output to the vertical signal line 17.

Next, similarly to time t8, the control signals SW3a and SWL become low. As a result, the selection transistor Tr6a and the low-gain transistor Tr9 are turned off. Therefore, the output of the signal to the vertical signal line 17 is stopped.

Next, the clamp mode will be described.

In the clamp mode, the reset transistor Tr1, the voltage control transistors Tr5 and Tr5a, and the capacitance switching transistor Tr7 are in an on-state. Further, in the clamp mode, the current control transistor Tr3, the selection transistors Tr6 and Tr6a, the high-gain transistor Tr8, and the low-gain transistor Tr9 are in an off-state.

As in the second embodiment, the pixel circuit may be expanded to two gain states, high gain or low gain states. Also in this case, the same effects as in the first embodiment can be obtained.

### Third Embodiment

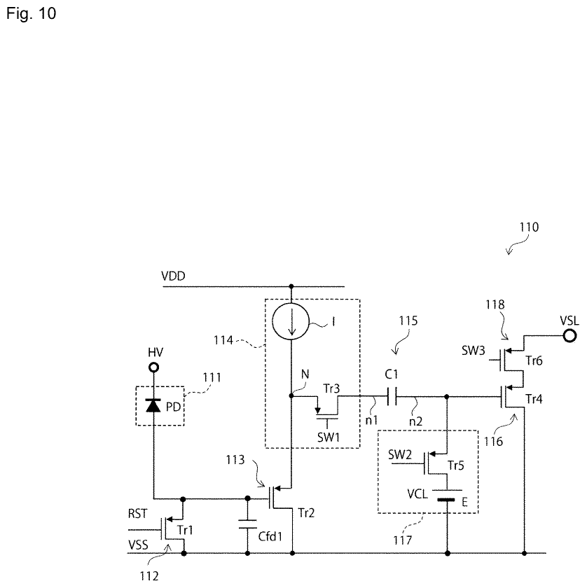

FIG. 10 is a circuit diagram showing an example of the configuration of the pixel 110 according to the third embodiment. The third embodiment differs from the first embodiment in the arrangement of the control transistor Tr3.

As shown in FIG. 10, the control transistor Tr3 is connected between the node N between the first amplification transistor Tr2 and the current source I, and the clamp capacitance C1. Even with this arrangement, the control transistor Tr3 can bring the first end n1 of the clamp capacitance C1 into a high impedance state. Regarding the current source I, current control is performed by turning it on or off in the original current source generation circuit unit.

As in the third embodiment, the arrangement of the current control transistor Tr3 (control transistor Tr3) may be changed. Also in this case, effects similar to those of the first embodiment can be obtained.

Note that the present technology can have the following configuration.

(1) An imaging device comprising:
a plurality of pixels; and
a holding unit that holds a signal output from the pixel,
the pixel including:
a conversion unit that converts radiation or light into charges;
a charge storage unit that stores the charges;
a reset unit that resets the charges stored in the charge storage unit;
a first amplification unit that amplifies a signal based on the charges stored in the charge storage unit;
a second amplification unit that amplifies the signal amplified by the first amplification unit and outputs the signal such that the signal is held in the holding unit;
a first capacitor connected between an output portion of the first amplification unit and an input portion of the second amplification unit; and
a voltage control unit that controls a voltage at an input portion of the second amplification unit.

(2) The imaging device according to (1), wherein
the holding unit is arranged outside the pixel.

(3) The imaging device according to (1) or (2), further including:
a signal line connected between each of the pixels and the holding unit, wherein the holding unit holds the signal output from the pixel via the signal line.

(4) The imaging device according to any one of (1) to (3), further including:
an ADC (Analog to Digital Converter) that converts a signal held by the holding unit into a digital signal.

(5) The imaging device according to (4), wherein
the voltage control unit controls the input portion of the second amplification unit to a first voltage before reading the pixel signal based on the charge converted by the conversion unit, and
the ADC converts a signal held by the holding unit after reading the pixel signal into a digital signal based on a second voltage signal corresponding to the first voltage, which is output from the second amplification unit before reading the pixel signal.

(6) The imaging device according to (5), wherein
the ADC further includes:
a comparison unit that outputs a comparison result between the signal held by the holding unit and a reference signal;
a feedback unit that feeds back the comparison result from the comparison unit to an input portion of the comparison unit to which the reference signal is input before reading the pixel signal; and
a second capacitor connected between a reference signal generation unit that generates the reference signal and the input portion of the comparison unit, and the second capacitor holds a voltage difference between the second voltage and an initial voltage of the reference signal, the voltage level of which changes over time, before reading the pixel signal.

(7) The imaging device according to (6), wherein
the feedback unit is a switch that can be opened and closed, and is connected between the comparison result output portion of the comparison unit and the input portion of the comparison unit, and
the second capacitor holds a voltage difference between the initial voltage and the second voltage before the pixel signal is read and when the switch changes from a closed state to an open state.

(8) The imaging device according to any one of (4) to (7), wherein
the holding unit and the ADC are shared by a plurality of the pixels, and
in parallel with the ADC converting a first pixel signal held by the holding unit into a digital signal, before reading the pixel signal based on the charge converted by the conversion unit in a second pixel, the voltage control unit controls the input portion of the second amplification unit to a first voltage, and
the second amplification unit outputs a second voltage signal corresponding to the first voltage.

(9) The imaging device according to (8), wherein
the second pixel is a pixel from which the pixel signal is read next to the first pixel.

(10) The imaging device according to any one of (1) to (9), wherein
a plurality of pixels are arranged in a matrix, and
a plurality of the holding units that hold signals output from each of the plurality of pixels included in one pixel column in parallel are provided.

(11) The imaging device according to any one of (1) to (10), wherein
in a period between a readout period in which a signal is read and a shutter period in which the first capacitor holds a voltage based on an operation of the reset unit and the first amplification unit, the reset unit continues to reset the charge converted by the conversion unit and stored in the charge storage unit and the voltage control unit continues to control the voltage at the input portion of the second amplification unit.

(12) The imaging device according to any one of (1) to (11), wherein the pixel further includes:
an additional capacitance unit that adds capacitance to the charge storage unit; and
a switching unit that switches addition of capacitance by the additional capacitance unit.

Aspects of the present disclosure are not limited to the aforementioned individual embodiments and include various modifications that those skilled in the art can achieve, and effects of the present disclosure are also not limited to the details described above. In other words, various additions, modifications, and partial deletion can be made without departing from the conceptual idea and the gist of the present disclosure that can be derived from the details defined in the claims and the equivalents thereof.

### REFERENCE SIGNS LIST

10 Imaging device,
13 AD conversion unit,
14 Reference signal generation unit,
17 Vertical signal line,
110 Pixel,
111 Conversion unit,
112 Reset unit,
113 First amplification unit,
114 Current control unit,
115 Noise storage unit,
116 Second amplification unit,
117 Voltage control unit,
118 Selection unit,
119 Capacitance switching unit,
130 AD converter,
133 Comparator,
1333 Comparison result output portion,
135 Switch,
18 Sample-and-hold circuit,
181 Switch,
Caz Capacitor,
Csh Capacitor,
C1 Clamp capacitance,
C2 Clamp capacitance,
Cfd1 Charge storage unit,
Cfd2 Additional capacitance unit,
Tr1 Reset transistor,
Tr2 First amplification transistor,
Tr3 Current control transistor,
Tr4 Second amplification transistor,
Tr5 Voltage control transistor,
Tr6 Selection transistor,
VCL Clamp voltage

1. An imaging device comprising:
a plurality of pixels; and
a holding unit that holds a signal output from the pixel,
the pixel including:
a conversion unit that converts radiation or light into charges;
a charge storage unit that stores the charges;
a reset unit that resets the charges stored in the charge storage unit;
a first amplification unit that amplifies a signal based on the charges stored in the charge storage unit;
a second amplification unit that amplifies the signal amplified by the first amplification unit and outputs the signal such that the signal is held in the holding unit;
a first capacitor connected between an output portion of the first amplification unit and an input portion of the second amplification unit; and
a voltage control unit that controls a voltage at an input portion of the second amplification unit.

2. The imaging device according to claim 1, wherein
the holding unit is arranged outside the pixel.

3. The imaging device according to claim 1, further comprising:
a signal line connected between each of the pixels and the holding unit, wherein the holding unit holds the signal output from the pixel via the signal line.

4. The imaging device according to claim 1, further comprising:
an ADC (Analog to Digital Converter) that converts a signal held by the holding unit into a digital signal.

5. The imaging device according to claim 4, wherein
the voltage control unit controls the input portion of the second amplification unit to a first voltage before reading the pixel signal based on the charge converted by the conversion unit, and
the ADC converts a signal held by the holding unit after reading the pixel signal into a digital signal based on a second voltage signal corresponding to the first voltage, which is output from the second amplification unit before reading the pixel signal.

6. The imaging device according to claim 5, wherein
the ADC further includes:
a comparison unit that outputs a comparison result between the signal held by the holding unit and a reference signal;
a feedback unit that feeds back the comparison result from the comparison unit to an input portion of the comparison unit to which the reference signal is input before reading the pixel signal; and
a second capacitor connected between a reference signal generation unit that generates the reference signal and the input portion of the comparison unit, and the second capacitor holds a voltage difference between the second voltage and an initial voltage of the reference signal, the voltage level of which changes over time, before reading the pixel signal.

7. The imaging device according to claim 6, wherein
the feedback unit is a switch that can be opened and closed, and is connected between the comparison result output portion of the comparison unit and the input portion of the comparison unit, and
the second capacitor holds a voltage difference between the initial voltage and the second voltage before the pixel signal is read and when the switch changes from a closed state to an open state.

8. The imaging device according to claim 4, wherein
the holding unit and the ADC are shared by a plurality of the pixels, and
in parallel with the ADC converting a first pixel signal held by the holding unit into a digital signal, before reading the pixel signal based on the charge converted by the conversion unit in a second pixel, the voltage control unit controls the input portion of the second amplification unit to a first voltage, and
the second amplification unit outputs a second voltage signal corresponding to the first voltage.

9. The imaging device according to claim 8, wherein
the second pixel is a pixel from which the pixel signal is read next to the first pixel.

10. The imaging device according to claim 1, wherein
a plurality of pixels are arranged in a matrix, and
a plurality of the holding units that hold signals output from each of the plurality of pixels included in one pixel column in parallel are provided.

11. The imaging device according to claim 1, wherein
in a period between a readout period in which a signal is read and a shutter period in which the first capacitor holds a voltage based on an operation of the reset unit and the first amplification unit, the reset unit continues to reset the charge converted by the conversion unit and stored in the charge storage unit and the voltage control unit continues to control the voltage at the input portion of the second amplification unit.

12. The imaging device according to claim 1, wherein
the pixel further includes:
an additional capacitance unit that adds capacitance to the charge storage unit; and
a switching unit that switches addition of capacitance by the additional capacitance unit.
